(19) United States
(12) Patent Application Publication
(10) Pub. No.: US 2017/0228154 A1
(43) Pub. Date: Aug. 10, 2017

(54) DEVICE AND METHOD FOR POWER LOSS PROTECTION IN SOLID STATE DRIVE

(71) Applicant: QUANTA STORAGE INC., Taoyuan City (TW)

(72) Inventors: An-Te Liu, Taoyuan City (TW); Tsu-Ying Chao, Taoyuan City (TW); Tzu-Wei Fang, Taoyuan City (TW)

(21) Appl. No.: 15/250,970

(22) Filed: Aug. 30, 2016

(30) Foreign Application Priority Data
Feb. 4, 2016 (CN) 201610080173.8

(51) Int. Cl. G06F 3/06

(52) U.S. Cl. CPC G06F 3/061; G06F 3/0688; G06F 3/0655

(57) ABSTRACT

A device and method for power loss protection in solid state drive are provided. A power loss region is created in a flash memory array and reserved as an independent storage space for storing power loss backup. When the power is interrupted, the SSD halts the operation of the host. Before the backup power is used up, the buffered data is directly written to a blank power loss block of the power loss region to form a power loss backup, and an auxiliary mark is created for confirming the most updated power loss backup. After the power is resumed, the power loss backup is directly read from the power loss region according to the most updated power loss auxiliary mark of the power loss backup to restore the original state of the SSD before the power is interrupted.

This application claims the benefit of People's Republic of China application Serial No. 201610080173.8, filed Feb. 4, 2016, the subject matter of which is incorporated herein by reference.

### BACKGROUND OF THE INVENTION

Field of the Invention

The invention relates in general to a solid state drive (SSD), and more particularly to a device and a method capable of avoiding data loss when the power of the SSD is interrupted.

Description of the Related Art

Solid state drive (SSD) integrates a plurality of non-volatile flash memory as one single storage device. In order to access data, the flash memory needs to perform programming using voltages, and the stored data may be easily damaged when the power is interrupted unexpectedly. Therefore, it has become an important task for the industries of SSD to avoid data loss.

When the SSD of the prior art receives an instruction from the host to access data, the SSD converts a logical page address (LPA) of the accessed data into a physical page address (PPA) according to a logical-physical mapping table created using a flash translation layer (PTL), and then transmits the physical page address to a flash memory. As indicated in FIG. 1, the flash memory 1 of the prior art includes a plurality of physical blocks 2 each containing a plurality of physical pages 3. Once the data is written to a physical page 3 of a physical block 2, the physical block 2 will become a non-blank data block 4, and any physical blocks 2 not containing write data are referred as free blocks 5, which can be used as backup blocks for the write data. When writing data, the flash memory 1 uses one physical page as a unit. When erasing data, the flash memory 1 uses one physical block as a unit. After the entire data of a block is erased, the block becomes a free block 5.

Before the flash memory 1 writes data to the physical page of the free block 5, all data stored in the host is firstly buffered in the buffer memory of the SSD. Then, the SSD selects a blank physical page 3 from the free block 5, writes the data of the buffer memory to the blank physical page 3, updates the corresponding address of the logical-physical mapping table, and registers the logical page address originally corresponding to the physical data block 4 as an invalid physical page 3, which can be recycled by performing a garbage collection process (GO) process by the SSD.

When the SSD of the prior art performs the garbage collection process, firstly, the SSD collects the data block 4 containing invalid physical pages 3 which are more than a predetermined quantity in the data region, as a garbage block 6 (such as the data block in gray color). Then, the data of the valid physical pages 3 of the garbage block 6 is copied and written to the blank physical page of the selected free block 5. After the copy is completed, all data of the garbage block 6 is erased, and as a new free block 5 for the backup of the write data.

The SSD further installs a sufficient capacitance as a backup power for power loss protection (PLP) according to the capacity of the buffer memory. Referring to FIG. 2, a schematic diagram of the data access process of the flash memory 1 of the prior art is shown. During the data accessing process, when the power of the SSD is interrupted after data A is written to a free block of the flash memory 1, the SSD immediately halts the operation of the host as well as the garbage collection process which is still in progress. Before the backup power is used up, and the data of the buffer memory is maintained, the data not written to the buffer memory of the SSD is written to the selected free block of the flash memory 1 to form a power loss backup A and registered in the logical-physical mapping table.

However, under the circumstance of frequent occurrences of power interruption, the garbage collection process of the SSD will be frequently interfered with by power interruption and halted. Thus, garbage blocks cannot be normally recycled to increase the capacity of free block backup. When the free blocks (gray data blocks as illustrated in the diagram) are completely occupied by the write data A, B and C and the power loss backups A and B created during the many occurrences of power interruption, there will be no free blocks available for storing data when the power is resumed, and the SSD will be shut down unexpectedly. Therefore, there are still many problems to be resolved in the technology field of SSD power loss protection.

### SUMMARY OF THE INVENTION

According to an object of the present invention, a solid state drive (SSD) power loss protection device is provided. A power loss region not controlled by a flash translation layer (FTL) is created in a flash memory array and reserved as an independent storage space for storing power loss backup to avoid data loss.

According to another object of the present invention, an SSD power loss protection method is provided. When the power is interrupted or resumed, a power loss backup is directly read from or written to a power loss region, such that the operation efficiency of SSD can be increased.

According to an alternate object of the present invention, a solid state drive (SSD) power loss protection method is provided. When the power is interrupted, a power loss backup is written to a power loss region, and an auxiliary mark is created for confirming the most updated power loss backup, such that the original state of the SSD before the power is interrupted can be correctly restored.

To achieve the above objects of the present invention, the SSD power loss protection device includes a controller, a buffer memory, a flash memory array and a translation layer unit. The controller receives an access command and a write data, controls the buffer memory to buffer data and controls the flash memory array to store data. The flash memory array includes a plurality of non-volatile flash memories. Each flash memory has a plurality of data blocks for storing a user data, free blocks recycled using a garbage collection process and used for the backup of the write data, and a power loss region formed of a plurality of power loss blocks and reserved as an independent storage space for power loss backup. When the power of the SSD is interrupted, and before the backup power is used up, the controller directly writes the data buffered in the buffer memory to a blank power loss block of the power loss region to form a power loss backup. When the power is resumed, the controller directly reads the power loss backup from the power loss region to restore the original state of the buffer memory before the power of the SSD is interrupted.

According to the SSD power loss protection device of the present invention, a power loss region is created in each, a part or one of the flash memories. The power loss region further creates an auxiliary mark in a backup column of the physical pages of the power loss blocks for confirming the most updated power loss backup.

According to the SSD power loss protection method of the present invention, when the power is interrupted, the SSD halts the operation of the host. Before the backup power is used up, the buffered data is directly written to a blank power loss block of the power loss region to form a power loss backup, and an auxiliary mark is created for confirming the most updated power loss backup. After the power is resumed, the power loss backup is directly read from the power loss region according to the most updated power loss auxiliary mark of the power loss backup to restore the original state of the SSD before the power is interrupted.

According to the SSD power loss protection method of the present invention, when the power is interrupted, the SSD halts the garbage collection process which is still in progress. The SSD creates an auxiliary mark in a backup column of the physical page of the written power loss block to which the power loss backup is written. The SSD directly writes the power loss backup to the power loss region or reads the power loss backup from the power loss region without using a translation layer unit. After the power loss backup is read, the data of the power loss backup is directly erased from the power loss block to form a blank power loss block which can further be recycled and used.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of structure of the flash memory of the prior art.

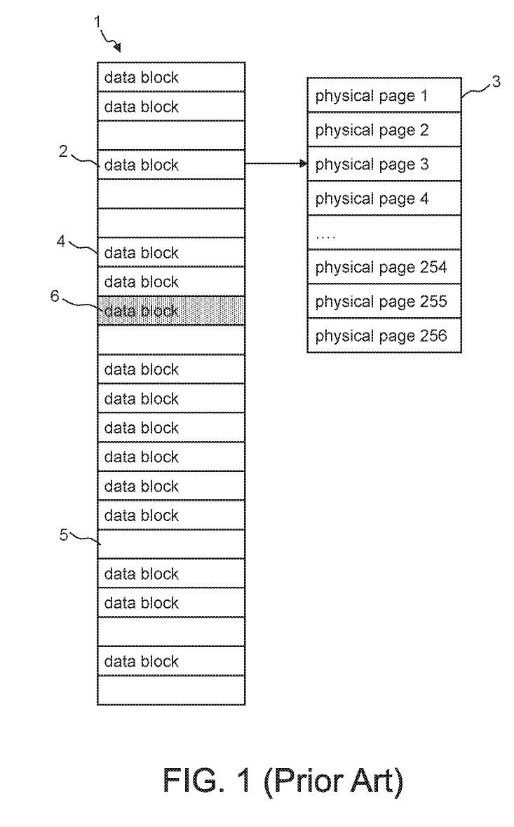

FIG. 2 shows a schematic diagram of data accessing the flash memory.

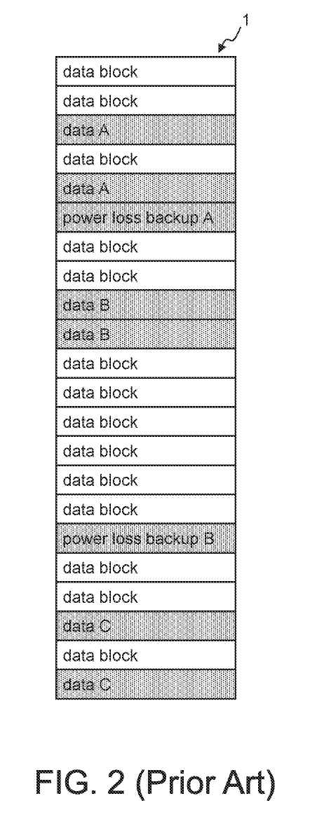

FIG. 3 shows a structural diagram of the SSD of the present invention.

FIG. 4 shows a structural diagram of the flash memory of the present invention.

FIG. 5 shows a schematic diagram of power loss protection of the flash memory of the present invention.

FIG. 6 shows a flowchart of an SSD power loss protection method of the present invention.

### DETAILED DESCRIPTION OF THE INVENTION

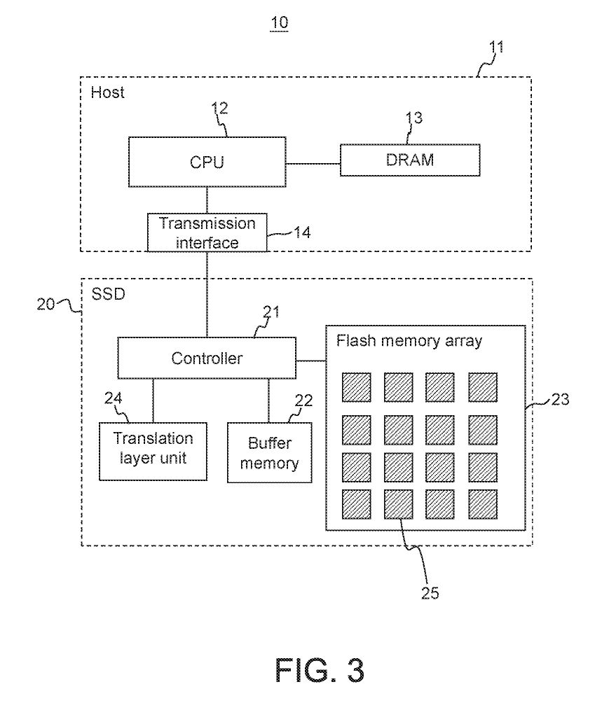

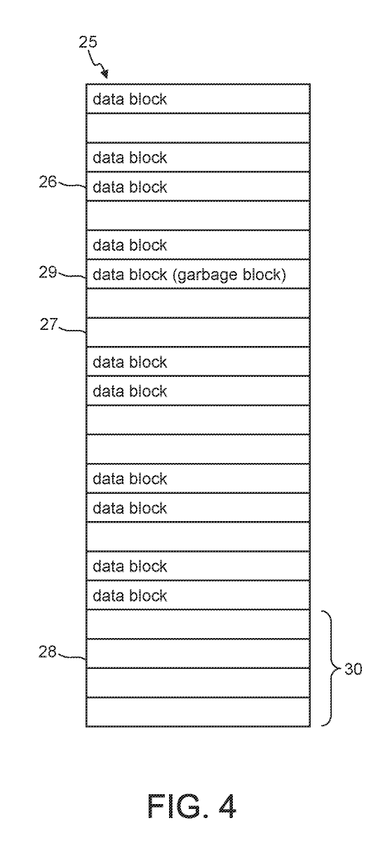

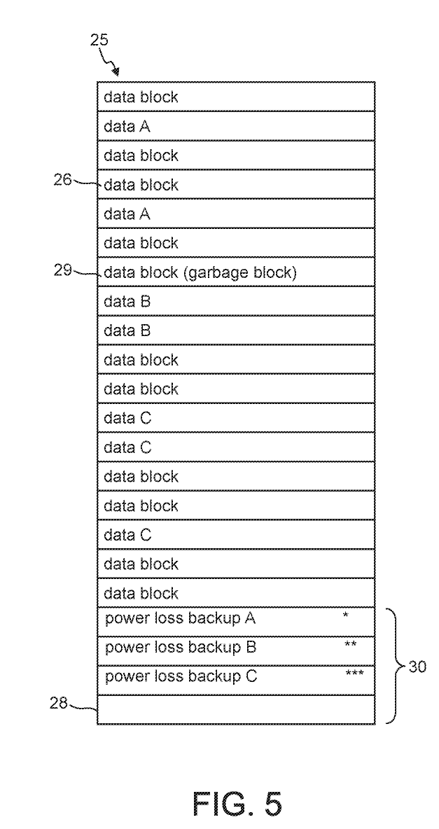

Refer to FIG. 3, FIG. 4 and FIG. 5. FIG. 3 is a structural diagram of the SSD of the present invention. FIG. 4 is a structural diagram of the flash memory of the present invention. FIG. 5 is a schematic diagram of power loss protection of the flash memory of the present invention. The solid state drive (SSD) 20 of FIG. 3 is used as a storage device of an electronic device 10. The host 11 of the electronic device 10 includes a central processing unit (CPU) 12 and a dynamic random access memory (DRAM) 13. The CPU 12 works with the DRAM 13 to send the logical address of the access data to the SSD 20 connected to a transmission interface 14.

The SSD 20 of the present invention includes a controller 21, a buffer memory 22, a flash memory array 23 and a translation layer unit 24. The controller 21 receives an access command from the host 11 and buffers write data to the buffer memory 22. Based on the logical address of the access command, the controller 21 writes the buffered write data to the physical address of the flash memory array 23 corresponding to the logical address or reads data and transmits the read data to the DRAM 13 for the host 11 to backup, according to the logical-physical mapping table created in the flash memory array 23 by the translation layer unit 24 and the parameter of the translation layer.

The flash memory array 23 of the SSD 20 includes a plurality of non-volatile flash memories 25. As indicated in FIG. 4, the flash memory 25 has a plurality of physical blocks, each having a plurality of physical pages.

The physical blocks can be divided into data blocks 26, free blocks 27 and power loss blocks 28. The data blocks 26 are for storing user data. The free blocks 27 are the blocks recycled from the garbage block 29 formed of invalid data blocks 26 by the SSD 20 using a garbage collection process. A certain quantity of free blocks 27 are maintained for the SSD 20 to write data to. The power loss region 30 formed of a plurality of power loss blocks 28 is reserved as an independent storage space for power loss backup. Moreover, the power loss region 30 is not controlled by the translation layer unit 24. In the present embodiment, each flash memory 25 exemplarily has a power loss region 30. Depending on actual needs, the power loss region 30 can be created in a part of the flash memories 25 or one single flash memory 25.

In FIG. 5, the controller 21 of the SSD 20 receives write data A received from the host 11 and then buffers the received write data in the buffer memory 22. The SSD 20 selects a free block 27 of the flash memory 25, and then writes data A of the buffer memory 22 to the selected free block 27. The SSD 20 further registers the corresponding address in the logical-physical mapping table created by the translation layer unit 24. During the time slots of data accessing, the SSD 20 performs a garbage collection process on the registered abandoned garbage block 29 according to the logical-physical mapping table created by the translation layer unit 24 and the parameter of the translation layer to keep the quantity of backup free blocks 27 not less than a predetermined quantity so that normal operation of the SSD 20 can be maintained.

During the data accessing process, once the power of the SSD 20 is interrupted, the SSD 20 immediately halts the operation of the host 10 as well as the garbage collection process which is still in progress. Before the backup power of the SSD 20 is used up, a blank power loss block 28 is selected from the power loss region 30, and the data buffered in the buffer memory 22 is directly written to the blank power loss block 28 to form a power loss backup A without having to be registered in the logical-physical mapping table. Moreover, an auxiliary mark “*” is created in a backup column of the physical page for confirming the most updated power loss backup. Since the power loss region 30 is exclusive for power loss backup, the power loss region 30 will not be completely occupied by the write data written by the SSD 20. Thus, it can be assured that the power loss backup will be stored instantly to avoid data loss.

After the power is resumed, the SSD 20 directly reads the power loss backup A from the power loss region 30 according to the auxiliary mark of the most updated power loss backup without looking up the logical-physical mapping table, restores the original state of the buffer memory 22 before the power of the SSD 20 is interrupted, and directly erases the data of the power loss backup A from the power loss block 28 to form a blank power loss block 28 without using a garbage collection process. The blank power loss block 28 can further be recycled and used for future use next time when the power is interrupted again. The power loss region 30 is not controlled by the translation layer unit 24 and does not need to be recycled using the garbage collection process, not only increasing the efficiency of power loss protection of the SSD 20 but also avoiding the normal operation of the SSD 20 being affected.

If the power of the SSD 20 is interrupted frequently and the garbage collection process is repeatedly interfered with by power interruption and therefore terminates, the SSD 20 cannot normally erases the power loss block 28 of the power loss backup or recycles the garbage block 29 for backup use. Although the free blocks 27 could be completely occupied by the excessive write data A, B and C during the repeated occurrences of power interruption, the power loss region 30 of the present invention provides an independent reserved blank power loss block 28 for storing the power loss backup C, so that the last power loss backup does not affect the quantity of free blocks 27. Thus, power loss protection can be achieved to avoid data loss, and the SSD 20 can maintain normal operation.

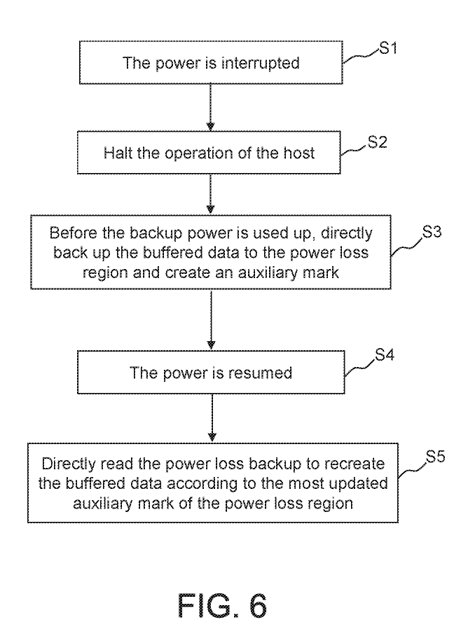

FIG. 6 is a flowchart of an SSD power loss protection method of the present invention. The SSD power loss protection method includes following steps. In step S1, the power of an SSD is interrupted. In step S2, the SSD immediately halts the operation of the host and the garbage collection process which is still in progress. In step S3, before the backup power is used up, the buffered data is written to a blank power loss block of the power loss region to form a power loss backup, and an auxiliary mark is created for confirming the most updated power loss backup. In step S4, the power is resumed. In step S5, the power loss backup is read according to the auxiliary mark of the most updated power loss backup, and the original state of the buffer memory before the power of the SSD is interrupted is restored.

According to the device and the method for SSD power loss protection of the present invention, a power loss region is created in the flash memory array of an SSD, and an independent storage space is reserved for power loss backup, such that the power loss region is not controlled by the translation layer unit and not recycled using a garbage collection process, and when the power is interrupted, the buffered data can be directly written to the power loss region. Moreover, an auxiliary mark is created for confirming the most updated power loss backup to avoid excessive write data completely occupying the backup region and affecting normal operation of the SSD. Thus, the efficiency of power loss protection can be increased, and the SSD will not be shut down unexpectedly.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A solid state drive (SSD) power loss protection device, comprising:
a controller for receiving an access command and a write data;
a buffer memory controlled by the controller to buffer the data;
a flash memory array, comprising a plurality of non-volatile flash memories, wherein each flash memory comprises a plurality of data blocks for storing a user data, free blocks recycled using a garbage collection process and used for the backup of the write data, and a power loss region formed of a plurality of power loss blocks not controlled by the translation layer unit and reserved as an independent storage space for power loss backup;
wherein, when the power of the SSD is interrupted, before the backup power is used up, the controller directly writes the data buffered in the buffer memory to a blank power loss block of the power loss region to form a power loss backup; when the power is resumed, the controller directly reads the power loss backup from the power loss region to restore the original state of the buffer memory before the power of the SSD is interrupted.

2. The SSD power loss protection device according to claim 1, wherein the power loss region is created in each flash memory.

3. The SSD power loss protection device according to claim 1, wherein the power loss region is created in a part of the flash memories.

4. The SSD power loss protection device according to claim 1, wherein the power loss region is created in one single flash memory.

5. The SSD power loss protection device according to claim 1, wherein auxiliary mark is created in the power loss region for confirming the most updated power loss backup.

6. The SSD power loss protection device according to claim 5, wherein the auxiliary mark is created in the backup column of the physical page of the power loss block.

7. A solid state drive (SSD) power loss protection method, comprising steps of:
interrupting the power;
halting the operation of the host by the SSD;
before the backup power is used up, directly writing the buffered data to a blank power loss block of the power loss region to form a power loss backup and creating an auxiliary mark for confirming the most updated power loss backup;
resuming the power;
reading the power loss backup from the power loss region directly according to the most updated auxiliary mark of power loss backup to restore the original state of the SSD before the power of the SSD is interrupted.

8. The SSD power loss protection method according to claim 7, wherein when the power is interrupted, the SSD halts the garbage collection process which is still in progress.

9. The SSD power loss protection method according to claim 7, wherein the power loss backup has an auxiliary mark in a backup column of the physical page of the power loss block to which the power loss backup is written.

10. The SSD power loss protection method according to claim 7, wherein the SSD directly writes the power loss backup to the power loss region or reads the power loss backup from the power loss region without using a translation layer unit.

11. The SSD power loss protection method according to claim 7, wherein after the power loss backup is read, the data of the power loss backup is directly erased from the power loss block to form a blank power loss block which can further be recycled and used.
